(19) United States
(12) Patent Application Publication
(10) Pub. No.: US 2026/0302312 A1
(43) Pub. Date: Oct. 1, 2026

(54) BATTERY, ALL-SOLID-STATE BATTERY, BATTERY MODULE, AND BATTERY MANUFACTURING METHOD

(71) Applicant: HONDA MOTOR CO., LTD., Tokyo (JP)

(72) Inventors: Hirokazu Watanabe, Wako-shi (JP); Yoshihiko Nakajima, Wako-shi (JP)

(21) Appl. No.: 19/541,489

(22) Filed: Feb. 17, 2026

(30) Foreign Application Priority Data
Mar. 25, 2025 (JP) 2025-049398

(51) Int. Cl. H01M 10/04

(52) U.S. Cl. CPC H01M 10/0436

(57) ABSTRACT

An all-solid-state battery includes: an electrode stack that is formed in a rectangular parallelepiped shape; an outer package of a laminated film, the outer package including a folded portion on a longer side of the electrode stack and housing the electrode stack; and a holder that is disposed on a shorter side of the electrode stack and is connected to the folded portion.

### CROSS-REFFERENCE TO RELATED APPLICATIONS

This application is based on and claims the benefit of priority from Japanese Patent Application No. 2025-049398 filed in Japan on Mar. 25, 2025, the contents of which are hereby incorporated by reference in their entirety.

### BACKGROUND OF THE INVENTION

### Field of the Invention

The present invention relates to a battery, an all-solid-state battery, a battery module, and a battery manufacturing method.

### Description of Related Art

In recent years, research and development on batteries that contribute to improvements in energy efficiency have been conducted in order to enable more people to secure access to affordable, reliable, sustainable, and advanced energy.

Meanwhile, the internal pressure of a battery changes due to pressure reduction treatment during a manufacturing process, gas generation accompanying charge and discharge, or the like in some cases. Such a change in the internal pressure of the battery can cause deformation such as expansion or contraction of an outer package of a laminated film. For example, if a battery that has expired a warranty period is continuously used for a long time, there is a possibility that an amount of deformation of the outer package will increase, and a welded portion of the outer package will cleave due to stress at the time of deformation. Therefore, it has been proposed that a protective member that restricts deformation of the outer package due to a change in internal pressure to prevent the welded portion from cleaving is housed inside the outer package.

Japanese Unexamined Patent Application, First Publication No. 2022-14715 discloses a secondary battery (a laminated battery) in which a protective member is housed inside an outer package. This battery includes an electrode body including a terminal connection portion, an outer package including a welded portion, an electrode terminal, a main holder, a side holder, and resin. The main holder is disposed in a state where the electrode terminal is sandwiched between the electrode body and the outer package in a stacking direction. The side holder is attached to both ends of a side surface including the terminal connection portion of the electrode body. The side holder has a structure of being fitted into the main holder.

In the constitution of Japanese Unexamined Patent Application, First Publication No. 2022-14715, the side holders attached to the electrode body and the main holder serving as the protective member are fitted into and fixed to each other, and therefore there is room for improvement in a reduction in the number of parts.

In order to solve the problem described above, it is an object of the present application to reduce the number of parts. This results in contribution to improvements in energy efficiency.

### SUMMARY OF THE INVENTION

As a means for solving the problem described above, aspects of the present invention have the following constitutions.

(1) A battery in an aspect of the present invention (for example, an all-solid-state battery 1 according to an embodiment) includes: an electrode stack (for example, an electrode stack 2 according to the embodiment) that is formed in a rectangular parallelepiped shape; an outer package (for example, an outer package 3 according to the embodiment) of a laminated film, the outer package including a folded portion (for example, a folded portion 30 according to the embodiment) on a longer side of the electrode stack and housing the electrode stack; and a holder (for example, a holder 100 according to the embodiment) that is disposed on a shorter side of the electrode stack and is connected to the folded portion.

By employing this constitution, the holder is connected to the folded portion of the outer package, and therefore a separate member configured to connect the outer package to the holder (for example, the side holder disclosed in Japanese Unexamined Patent Application, First Publication No. 2022-14715, or the like) is not required. Accordingly, the number of parts can be reduced. This results in contribution to improvements in energy efficiency.

(2) In the battery according to (1)described above, an opening (for example, an opening 101 according to the embodiment) that houses an end of the folded portion may be formed in the holder.

By employing this constitution, the outer package and the holder can be connected to each other by housing the end of the folded portion of the outer package in the opening of the holder. This contributes to space saving in comparison with the case of connection using a holding mechanism such as a chucking mechanism. As a result, the battery can be reduced in size, and the volumetric energy density can be made efficient.

(3) In the battery according to (2) described above, the holder may include a first holding member (for example, a first holding member 110 according to the embodiment) and a second holding member (for example, a second holding member 120 according to the embodiment) that are disposed to be superimposed onto each other in a thickness direction of the electrode stack, and the opening may be formed in any one of the first holding member and the second holding member.

By employing this constitution, the first holding member and the second holding member are disposed to be superimposed onto each other in the thickness direction of the electrode stack, and therefore the outer package can be more suitably protected from external factors. Furthermore, the outer package and the holder can be connected to each other by housing the end of the folded portion of the outer package in the opening of any one of the first holding member and the second holding member. Therefore, connection becomes easy in comparison with a case where the end of the folded portion of the outer package is housed in the opening of each of the first holding member and the second holding member.

(4) In the battery according to (3) described above, a through-hole (for example, a through-hole 31 according to the embodiment) that is open in the thickness direction may be formed in the outer package, and the holder may include an uneven structure (for example, an uneven structure 130 according to the embodiment) that is fitted through the through-hole, in a portion that corresponds to the through-hole.

By employing this constitution, the uneven structure enables the outer package and the holder to be positioned. As a result, the outer package and the holder can be prevented from being relatively displaced (relative displacement can be restricted).

(5) In the battery according to (4) described above, the uneven structure may include: a protrusion (for example, a protrusion 131 according to the embodiment) that is formed in any one of the first holding member and the second holding member and protrudes in the thickness direction; and a recess (for example, a recess 132 according to the embodiment) that is formed in another of the first holding member and the second holding member, the protrusion being capable of being fitted into the recess.

By employing this constitution, the outer package and the holder can be positioned by fitting the protrusion into the recess of the first holding member or the second holding member. Therefore, positioning is easily performed in comparison with a case where the uneven structure includes a hole formed in each of the first holding member and the second holding member, and a shaft that is inserted into each of the holes.

(6) In the battery according to (5) described above, the opening may be formed in the second holding member, and the first holding member may be disposed vertically above the second holding member.

By employing this constitution, the outer package and the holder can be connected to each other by housing the end of the folded portion of the outer package in the opening of the second holding member. Furthermore, in this connection state, the second holding member is covered with the first holding member from an upper side in the vertical direction, and the protrusion is fitted into the recess of the first holding member or the second holding member, and therefore the outer package and the holder can be positioned. This facilitates assembly work in comparison with a case where the first holding member is disposed on a lower side in the vertical direction of the second holding member.

(7) An all-solid-state battery in an aspect of the present invention (for example, the all-solid-state battery 1 according to the embodiment) includes: an electrode stack (for example, the electrode stack 2 according to the embodiment) that is formed in a rectangular parallelepiped shape, and includes a positive electrode layer (for example, a positive electrode layer 6 or 7 according to the embodiment) formed in a plate shape, a negative electrode layer (for example, a negative electrode layer 8 or 9 according to the embodiment) facing the positive electrode layer in a thickness direction, and a solid electrolyte layer (for example, a solid electrolyte layer 11 or 12 according to the embodiment) disposed between the positive electrode layer and the negative electrode layer; an outer package (for example, the outer package 3 according to the embodiment) of a laminated film, the outer package including a folded portion (for example, the folded portion 30 according to the embodiment) on a longer side of the electrode stack and housing the electrode stack; and a holder (for example, the holder 100 according to the embodiment) that is disposed on a shorter side of the electrode stack and is connected to the folded portion.

By employing this constitution, in the all-solid-state battery, the holder is connected to the folded portion of the outer package, and therefore a separate member configured to connect the outer package to the holder (for example, the side holder disclosed in Japanese Unexamined Patent Application, First Publication No. 2022-14715, or the like) is not required. Accordingly, the number of parts can be reduced. This results in contribution to improvements in energy efficiency.

(8) In the all-solid-state battery according to (7) described above, the negative electrode layer may include a negative electrode active material layer (for example, a negative electrode active material layer 15 according to the embodiment) made of an active material of a lithium-based material or a silicon-based material.

By employing this constitution, in an all-solid-state battery including a Li negative electrode or a Si negative electrode, displacement can be prevented at the time of stacking.

(9) A battery module in an aspect of the present invention (for example, a battery module 200 according to the embodiment) includes: the all-solid-state battery according to (7) or (8) described above; and an elastic member (for example, an elastic member 201 according to the embodiment) that is adjacent to the all-solid-state battery in the thickness direction.

By employing this constitution, in the battery module, the holder is connected to the folded portion of the outer package, and therefore a separate member configured to connect the outer package to the holder (for example, the side holder disclosed in Japanese Unexamined Patent Application, First Publication No. 2022-14715, or the like) is not required. Accordingly, the number of parts can be reduced. This results in contribution to improvements in energy efficiency. Furthermore, in applying pressure after the all-solid-state battery and the elastic member have been stacked, the all-solid-state battery or the elastic member can be prevented from being damaged due to a load at the time of applying pressure.

(10) A battery manufacturing method in an aspect of the present invention includes: preparing an electrode stack (for example, the electrode stack 2 according to the embodiment) formed in a rectangular parallelepiped shape, an outer package (for example, the outer package 3 according to the embodiment) of a laminated film, the outer package including a folded portion (for example, the folded portion 30 according to the embodiment) on a longer side of the electrode stack and housing the electrode stack, a first holding member (for example, the first holding member 110 according to the embodiment), and a second holding member (for example, the second holding member 120 according to the embodiment) including an opening (for example, the opening 101 according to the embodiment) capable of housing an end of the folded portion, the first holding member and the second holding member serving as a holder (for example, the holder 100 according to the embodiment) that is connected to the folded portion; housing the end of the folded portion of the outer package in the opening of the second holding member; and attaching the first holding member to the second holding member in a state where the end of the folded portion is housed.

By employing this method, the first holding member can be attached to the second holding member in a state where the end of the folded portion of the outer package is housed in the opening of the second holding member. As a result, a separate member configured to connect the outer package to the holder (for example, the side holder disclosed in Japanese Unexamined Patent Application, First Publication No. 2022-14715, or the like) is not required. Accordingly, the number of parts can be reduced. This results in contribution to improvements in energy efficiency. This also results in contribution to space saving in comparison with the case of connection using a holding mechanism such as a chucking mechanism. As a result, the battery can be reduced in size, and the volumetric energy density can be made efficient.

In an aspect of the present invention, the number of parts can be reduced, and this contributes to improvements in energy efficiency.

### BRIEF DESCRIPTION OF THE DRAWINGS

FIG. 1 is a perspective view of an all-solid-state battery according to an embodiment;

FIG. 2 is a plan view illustrating a state where a holder has been removed in the all-solid-state battery according to the embodiment;

FIG. 3 is a cross-sectional view taken along line III-III of FIG. 2;

FIG. 4 is a cross-sectional view taken along line IV-IV of FIG. 2;

FIG. 5 is an exploded perspective view of the holder according to the embodiment;

FIG. 6 is a perspective view illustrating a periphery of a folded portion of an outer package according to the embodiment;

FIG. 7 is a diagram explaining a vertically divided shape of the holder according to the embodiment;

FIG. 8 is a diagram explaining one process of a battery manufacturing method according to the embodiment;

FIG. 9 is a diagram that follows FIG. 8 and explains one process of the battery manufacturing method; and

FIG. 10 is a perspective view of a battery module according to the embodiment.

### DETAILED DESCRIPTION OF THE INVENTION

Hereinafter, an embodiment of the present invention will be described with reference to the drawings. The description below will be provided by using an all-solid-state battery as an example of a battery. In the description below, expressions indicating relative or absolute disposition, such as “parallel”, “orthogonal”, “center”, and “coaxial”, do not only strictly mean such disposition but also include a state of being relatively displaced with a tolerance, or an angle or a distance at which the same function is obtainable. In the drawings used in the description below, the scale of each member is appropriately changed in order to make each of the members recognizable in size.

### All-Solid-State Battery

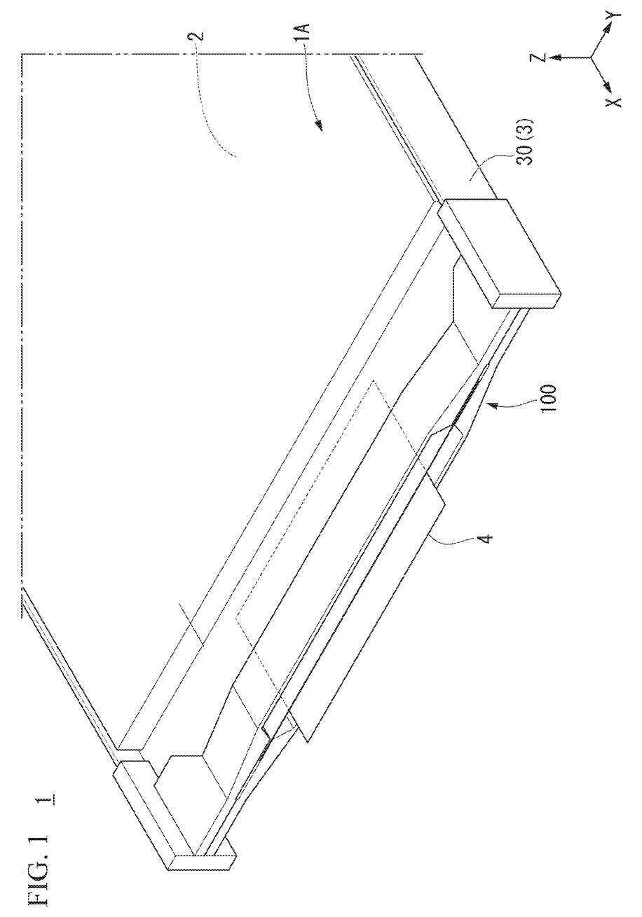

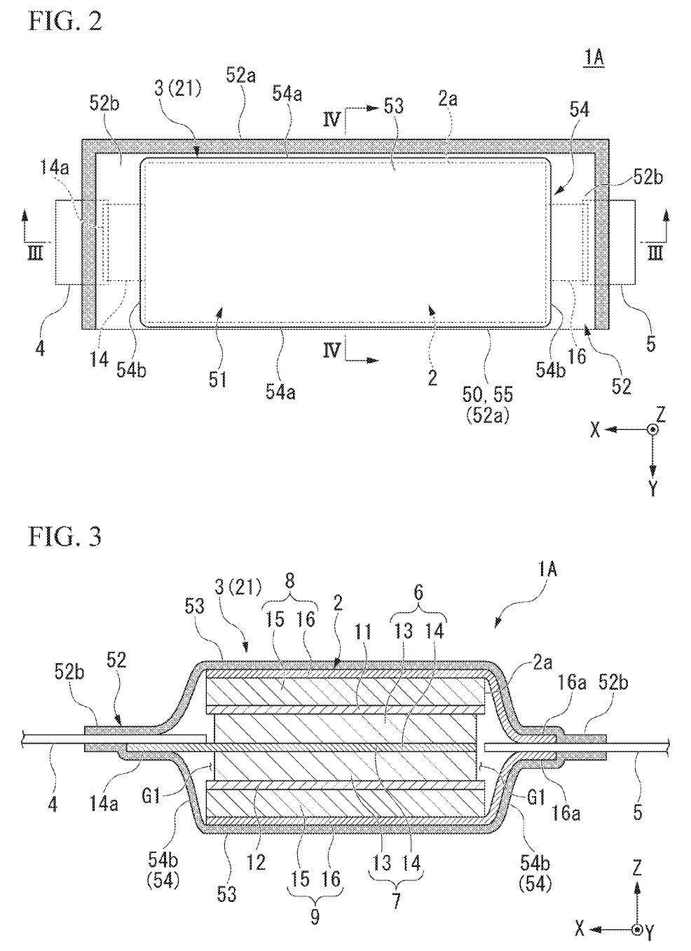

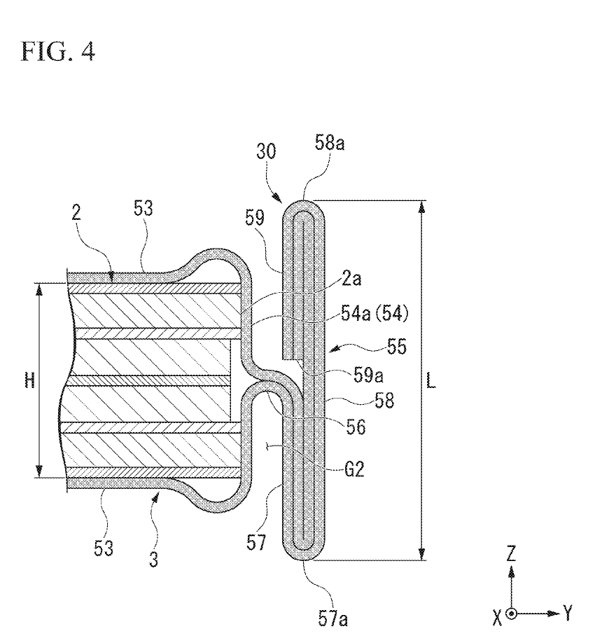

FIG. 1 is a perspective view of an all-solid-state battery 1 according to an embodiment. FIG. 2 is a plan view illustrating a state where a holder 100 has been removed in the all-solid-state battery 1 according to the embodiment. FIG. 3 is a cross-sectional view taken along line III-III of FIG. 2. FIG. 4 is a cross-sectional view taken along line IV-IV of FIG. 2.

With reference to all of FIGS. 1 to 4, the all-solid-state battery 1 includes a battery body 1A and the holder 100.

The description below will be provided by using an XYZ orthogonal coordinate system, as necessary. An X direction corresponds to a depth direction (a longer-side direction) of the battery body. A Y direction corresponds to a width direction (a shorter-side direction) of the battery body. A Z direction corresponds to a thickness direction of the battery body. “Longer-side” and “shorter-side” respectively correspond to a longer side and a shorter side of an electrode stack. The description below will be provided under the assumption that, in the X direction, the Y direction, and the Z direction, a side of an arrow in the drawing is a plus (+) side, and a side opposite to the arrow is a minus (−) side. A +Z side corresponds to an upper side in a vertical direction, and a −Z side corresponds to a lower side in the vertical direction.

### Battery Body

The battery body 1A includes an electrode stack 2, an outer package 3 that covers the electrode stack 2, and lead tabs 4 and 5 (a positive electrode tab 4 and a negative electrode tab 5) that are led out from the electrode stack 2 through the outer package 3 to the outside.

### Electrode Stack

The electrode stack 2 is formed in a rectangular parallelepiped shape as a whole. The electrode stack 2 includes positive electrode layers 6 and 7 (a first positive electrode layer 6 and a second positive electrode layer 7) that are each formed in a plate shape, negative electrode layers 8 and 9 (a first negative electrode layer 8 and a second negative electrode layer 9) that face the respective positive electrode layers 6 and 7 in the thickness direction, and solid electrolyte layers 11 and 12 (a first solid electrolyte layer 11 and a second solid electrolyte layer 12) that are disposed between the positive electrode layers 6 and 7 and the negative electrode layers 8 and 9, respectively.

Each of the positive electrode layers 6 and 7 includes a positive electrode active material layer 13. The positive electrode layers 6 and 7 include a common positive electrode current collector 14. The positive electrode active material layers 13 are disposed on both sides of the positive electrode current collector 14. Examples of an active material constituting the positive electrode active material layer 13 include lithium cobaltate, lithium nickelate, lithium manganate, lithium metal phosphate, lithium nickel cobalt manganate, and lithium nickel cobalt aluminate.

The positive electrode current collector 14 is led out from the positive electrode active material layer 13 in a +X direction (a direction roughly orthogonal to the stacking direction of the positive electrode active material layer 13). The positive electrode current collector 14 is formed of, for example, a metal foil, a metal sheet, or a metal plate of aluminum, copper, stainless steel, or the like. Note that the Z direction corresponds to the stacking direction. An XY direction corresponds to a plane direction orthogonal to the stacking direction.

The first negative electrode layer 8 of the negative electrode layers 8 and 9 faces the first positive electrode layer 6 of the positive electrode layers 6 and 7 in the stacking direction. The second negative electrode layer 9 of the negative electrode layers 8 and 9 faces the second positive electrode layer 7 of the positive electrode layers 6 and 7 in the stacking direction. The first negative electrode layer 8 is disposed on a side opposite to a side of the second positive electrode layer 7 relative to the first positive electrode layer 6. The second negative electrode layer 9 is disposed on a side opposite to a side of the first positive electrode layer 6 relative to the second positive electrode layer 7.

Each of the negative electrode layers 8 and 9 includes a negative electrode active material layer 15. The area of the negative electrode active material layer 15 is larger than the area of the positive electrode active material layer 13. The negative electrode active material layer 15 protrudes from the positive electrode active material layer 13 in the plane direction. A clearance G1 is formed between respective outer peripheral portions of the negative electrode layers 8 and 9 in the stacking direction. The clearance G1 is formed between the positive electrode layers 6 and 7 and the negative electrode layers 8 and 9 in the plane direction.

Examples of an active material constituting the negative electrode active material layer 15 include a lithium-based material and a silicon-based material. Examples of the lithium-based material include Li metal and a Li alloy. Examples of the silicon-based material include Si and SiO. Other examples of the active material constituting the negative electrode active material layer 15 include carbon materials such as graphite, soft carbon, and hard carbon, tin-based materials (Sn, SnO, and the like), and lithium titanate.

Each of the negative electrode layers 8 and 9 includes a negative electrode current collector 16 disposed on a side opposite to the positive electrode layers 6 and 7 with the negative electrode active material layer 15 interposed therebetween. The negative electrode current collector 16 is formed of a material that is similar to that of the positive electrode current collector 14. Each of the negative electrode current collectors 16 is led out from each of the negative electrode active material layers 15 in a −X direction. A led-out direction (the −X direction) of each of the negative electrode current collectors 16 is a direction opposite to a led-out direction (the +X direction) of the positive electrode current collector 14. A distal end 16a in the led-out direction of each of the negative electrode current collectors 16 is disposed on a center side in the stacking direction.

The first solid electrolyte layer 11 of the solid electrolyte layers 11 and 12 is disposed between the first positive electrode layer 6 and the first negative electrode layer 8. The second solid electrolyte layer 12 of the solid electrolyte layers 11 and 12 is disposed between the second positive electrode layer 7 and the second negative electrode layer 9. The area of each of the solid electrolyte layers 11 and 12 is equal to the area of the negative electrode active material layer 15.

Each of the solid electrolyte layers 11 and 12 is formed of, for example, a solid electrolyte having ion conductivity. Examples of a material of the solid electrolyte layers 11 and 12 include a sulfide-based solid electrolyte material, an oxide-based solid electrolyte material, a nitride-based solid electrolyte material, and a halide-based solid electrolyte material.

Note that the solid electrolyte layers 11 and 12, the positive electrode active material layer 13, and the negative electrode active material layer 15 that have been described above may be formed by binding particles of a substance constituting each layer by using an organic polymer compound-based binder. A material for forming each of the layers is not limited to the above, and can be changed according to design specifications.

### Outer Package

The outer package 3 includes a folded portion 30 on the longer side of the electrode stack 2. The outer package 3 houses the electrode stack 2. The outer package 3 is formed, for example, by folding, in half, a laminated film 21 forming the outer package 3. The laminated film 21 is formed, for example, by covering front and reverse surfaces of a metal layer with a resin layer (an insulating layer). The outer package 3 is constituted by the laminated film 21, and therefore the outer package 3 has flexibility capable of following expansion and contraction of the electrode stack 2. The flexibility capable of following the expansion and contraction of the electrode stack 2 can be obtained by a way of wrapping the electrode stack 2 in the outer package 3, the shape and structure of the outer package 3, or the like.

The outer package 3 includes a covering portion 51 that covers the entirety of the electrode stack 2, and a peripheral edge portion 52 that is formed around the covering portion 51. The covering portion 51 and the peripheral edge portion 52 are integrally molded. The covering portion 51 is formed in a rectangular parallelepiped shape to correspond to the shape of the electrode stack 2. The covering portion 51 includes a pair of end surface covering portions 53 that cover the negative electrode current collector 16 from the outside in the stacking direction, and a side surface covering portion 54 that is coupled to outer peripheral edges of the pair of end surface covering portions 53 and covers an outer peripheral portion 2a of the electrode stack 2. The end surface covering portions 53 and the side surface covering portion 54 are integrally molded.

The outer peripheral portion 2a of the electrode stack 2 is a side surface portion on an outer side in the plane direction. The side surface covering portion 54 includes longer side surface covering portions 54a that face each other in the shorter-side direction when viewed in the stacking direction, and a pair of shorter side surface covering portions 54b that face each other in the longer-side direction.

The peripheral edge portion 52 is formed by superimposing peripheral edges located on a side opposite to a side of the end surface covering portions 53 relative to the side surface covering portion 54 onto each other in the stacking direction. The peripheral edge portion 52 includes a pair of longer peripheral edge portions 52a formed on sides of the longer side surface covering portions 54a, and a pair of shorter peripheral edge portions 52b formed on sides of the shorter side surface covering portions 54b. The peripheral edge portions 52a and 52b are respectively formed at the center in the stacking direction of the side surface covering portions 54a and 54b.

In the example of FIG. 2, one of the pair of longer peripheral edge portions 52a includes a surplus portion 50 having a large surplus of the longer peripheral edge portion 52a. The surplus portion 50 (the surplus of the longer peripheral edge portion 52a) is folded to form a bent portion 55. In the present embodiment, the bent portion 55 (the folded portion 30) is formed by folding the surplus portion 50 of each of the pair of longer peripheral edge portions 52a. Note that a shape obtained by combining the shorter peripheral edge portion 52b that is elongated in the Y direction and the folded portions 30 located on both sides in the Y direction is formed in an I-shape elongated in the Y direction (an H-shape), when viewed in the X direction.

### Folded Portion

The folded portion 30 is formed by the bent portion 55. The bent portion 55 includes, in the surplus portion 50, a first extending portion 57 that is bent and extends from a proximal end 56 closer to the outer peripheral portion 2a of the electrode stack 2, a second extending portion 58 that is bent and extends from a distal end 57a located on a side opposite to the proximal end 56 in the first extending portion 57, and a third extending portion 59 that is bent and extends from a distal end 58a located on a side opposite to the first extending portion 57 in the second extending portion 58. The proximal end 56, the first extending portion 57, the second extending portion 58, and the third extending portion 59 constitute the folded portion 30.

The first extending portion 57 extends from the proximal end 56 in the −Z direction. The first extending portion 57 is formed to be flat in the stacking direction. A clearance G2 is formed between the first extending portion 57 and the longer side surface covering portion 54a. The first extending portion 57 may extend to an outer side in the stacking direction of the negative electrode current collector 16, when viewed in the plane direction. The distal end 57aof the first extending portion 57 may be disposed on an outer side in the stacking direction of the electrode stack 2, when viewed in the plane direction.

The second extending portion 58 extends from the distal end 57aof the first extending portion 57 in the +Z direction. The second extending portion 58 is formed to be flat in the stacking direction. The second extending portion 58 is disposed on a side opposite to a side of the electrode stack 2 relative to the first extending portion 57. The second extending portion 58 may extend to an outer side in the stacking direction of the negative electrode current collector 16, when viewed in the plane direction. The distal end 58a of the second extending portion 58 may be disposed on an outer side of the electrode stack 2 and on a side opposite to the distal end 57a of the first extending portion 57, when viewed in the plane direction. A length L between the distal end 57a of the first extending portion 57 and the distal end 58a of the second extending portion 58 may be greater than a thickness H of the electrode stack 2.

The third extending portion 59 extends from the distal end 58a of the second extending portion 58 in the −Z direction. The third extending portion 59 is formed to be flat in the stacking direction. The third extending portion 59 is disposed on a side of the electrode stack 2 relative to the second extending portion 58. The third extending portion 59 is disposed on a plane same as that of the first extending portion 57 in the stacking direction. The third extending portion 59 extends to a position in front of the proximal end 56. The distal end 59aof the third extending portion 59 is disposed to be close to the proximal end 56.

### Lead Tab

The lead tabs 4 and 5 are formed of, for example, a conductive metal sheet or metal plate. The lead tabs 4 and 5 are the positive electrode tab 4 and the negative electrode tab 5 that each extend in the plane direction. The battery body is connected to a charger or an electric load via the two lead tabs 4 and 5 to charge or discharge the electrode stack 2.

One end (a −X end) of the positive electrode tab 4 is connected to a distal end 14a of the positive electrode current collector 14. The distal end 14aof the positive electrode current collector 14 is connected to one surface (a −Z surface) of the one end (the −X end) of the positive electrode tab 4. Another end (a +X end) of the positive electrode tab 4 is led out to the outside of the outer package 3 via the shorter peripheral edge portion 52b of the outer package 3.

One end (a +X end) of the negative electrode tab 5 is connected to distal ends 16a of the negative electrode current collectors 16. The distal ends 16aof the negative electrode current collectors 16 are connected to both surfaces (a +Z surface and a −Z surface) of the one end (the +X end) of the negative electrode tab 5. A led-out direction (the −X direction) of the negative electrode tab 5 is a direction opposite to the led-out direction (the +X direction) of the positive electrode tab 4. Another end (a −X end) of the negative electrode tab 5 is led out to the outside of the outer package 3 via the shorter peripheral edge portion 52b of the outer package 3.

### Holder

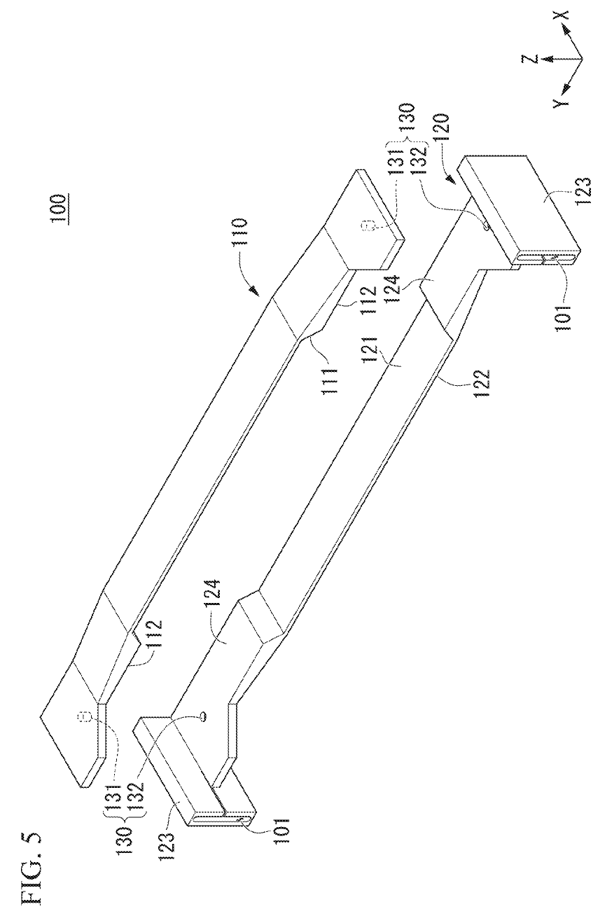

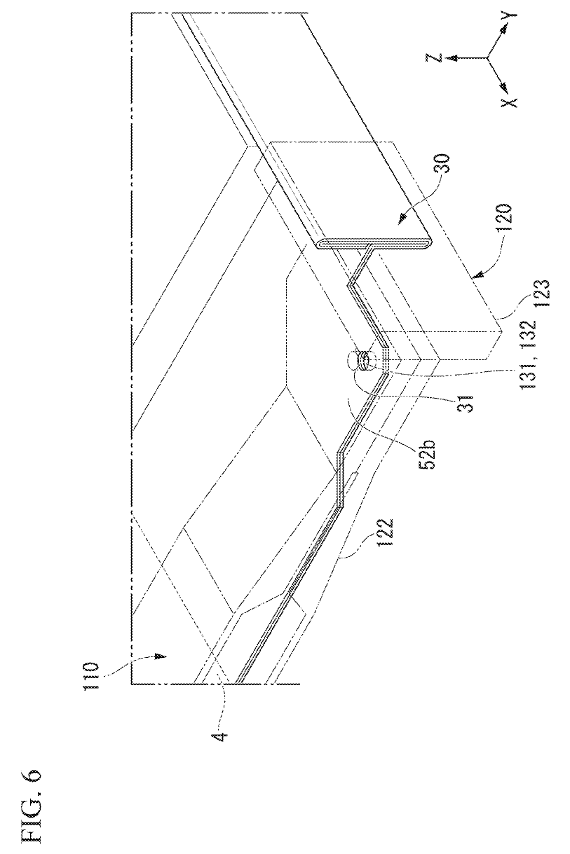

FIG. 5 is an exploded perspective view of the holder 100 according to the embodiment. FIG. 6 is a perspective view illustrating the periphery of the folded portion 30 of the outer package 3 according to the embodiment.

With further reference to FIGS. 5 and 6, the holder 100 is disposed on a side of the shorter side of the electrode stack 2. The holder 100 is disposed on both sides in the longer-side direction (the X direction) of the battery body 1A. The holder 100 overlaps each of the shorter peripheral edge portions 52b located on both sides in the X direction of the battery body 1A. The holder 100 is disposed to surround each of the lead tabs 4 and 5. The holder 100 includes an opening 101 that houses an end of the folded portion 30.

The holder 100 includes a first holding member 110 and a second holding member 120 that are disposed to be superimposed onto each other in the thickness direction of the electrode stack 2. The holder 100 is formed by combining the first holding member 110 and the second holding member 120. On a center side in the Y direction (in a portion that overlaps the lead tabs 4 and 5 in a plan view) of the first holding member 110 and the second holding member 120, steps 111 and 121 are respectively formed on surfaces that face each other in the Z direction. The steps 111 and 121 form a clearance between the first holding member 110 and the second holding member 120 in the Z direction on the center side in the Y direction. When the first holding member 110 and the second holding member 120 have been combined, the clearance enables the lead tabs 4 and 5 to be disposed with the shorter peripheral edge portions 52b interposed therebetween.

It is preferable that the first holding member 110 and the second holding member 120 be formed of a material capable of securing rigidity of the laminated film 21 (the outer package 3) in the battery body 1A (for example, a resin material having a predetermined strength). Examples of a material of which the first holding member 110 and second holding member 120 are formed include a thermoplastic resin such as polypropylene, polyethylene, or polyphenylene sulfide, and a thermosetting resin such as phenol resin or epoxy resin.

The opening 101 is formed in any one of the first holding member 110 and the second holding member 120. In the present embodiment, the opening 101 is formed in the second holding member 120. The first holding member 110 is disposed vertically above the second holding member 120.

The outer package 3 includes a through-hole 31 that is open in the thickness direction. The through-hole 31 is formed on an outer side in the Y direction of the shorter peripheral edge portion 52b (a portion that does not overlap the lead tab 4 or 5 in a plan view). The through-hole 31 is formed in a circular shape in the plan view. One through-hole 31 is formed on each of both outer sides in the Y direction of the shorter peripheral edge portion 52b. Note that a formation aspect (disposition, shape, the number of pieces, or the like) of the through-hole 31 is not limited to the above, and can be changed according to design specifications.

The holder 100 includes an uneven structure 130 that is fitted through the through-hole 31, in a portion that corresponds to the through-hole 31. The uneven structure 130 includes a protrusion 131 that is formed in any one of the first holding member 110 and the second holding member 120 and protrudes in the thickness direction, and a recess 132 that is formed in another of the first holding member 110 and the second holding member 120, the protrusion 131 being capable of being fitted into the recess 132. In the present embodiment, the protrusion 131 is formed in the first holding member 110. The recess 132 is formed in the second holding member 120.

### Vertically Divided Structure of Holder

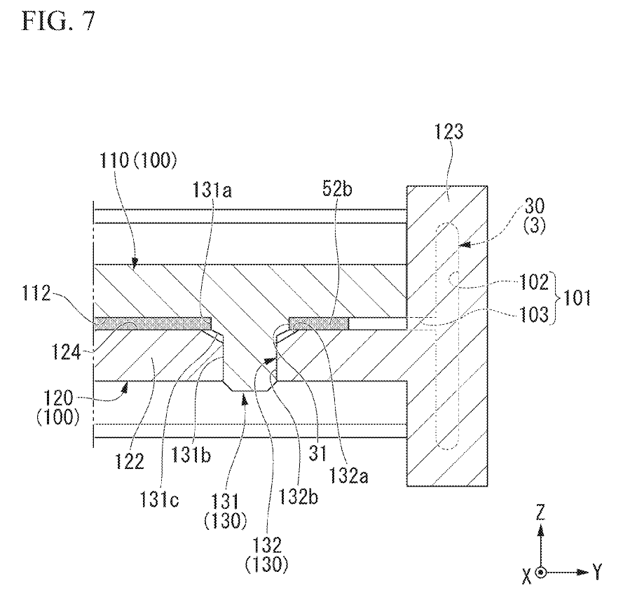

FIG. 7 is a diagram explaining a vertically divided shape of the holder 100 according to the embodiment.

With further reference to FIG. 7, the holder 100 is formed by combining the first holding member 110 and the second holding member 120 that are vertically divided. A shape obtained by combining the first holding member 110 and the second holding member 120 is formed in an I-shape elongated in the Y direction (an H-shape), when viewed in the X direction.

The first holding member 110 is a member that constitutes a +Z side portion (an upper portion) of the holder 100 and includes the protrusion 131 included in the uneven structure 130. The first holding member 110 is disposed above the lead tabs 4 and 5 with the shorter peripheral edge portions 52b interposed therebetween. In the first holding member 110, a lower surface 112 located on an outer side in the Y direction of the step 111 (in a portion that does not overlap the lead tab 4 or 5 in a plan view) is formed to be flat in the plane direction.

The second holding member 120 is a member that constitutes a −Z side portion (a lower portion) and a Y-direction outer end (a portion where the opening 101 is formed) of the holder 100, and includes the recess 132 included in the uneven structure 130. The second holding member 120 is disposed below the lead tabs 4 and 5 with the shorter peripheral edge portions 52b interposed therebetween. In the second holding member 120, an upper surface 124 located on an outer side in the Y direction of the step 121 (in a portion that does not overlap the lead tab 4 or 5 in a plan view) is formed to be flat in the plane direction.

The second holding member 120 includes a lateral wall 122 having a longer side in the Y direction, and longitudinal walls 123 that are coupled to both ends in the Y direction of the lateral wall 122 and have a longer side in the Z direction. The shape of the second holding member 120 (a shape obtained by combining the lateral wall 122 elongated in the Y direction and the longitudinal walls 123 located on both sides in the Y direction) is formed in an I-shape elongated in the Y direction (an H-shape), when viewed in the X direction. The lateral wall 122 is a portion that faces the first holding member 110 in the Z direction in the second holding member 120. The longitudinal wall 123 is a portion where the opening 101 is formed in the second holding member 120. The longitudinal wall 123 is formed in a rectangular parallelepiped shape elongated in the X direction to correspond to the shape of the folded portion 30.

The opening 101 opens a −X side portion of the longitudinal wall 123 in the −X direction. The opening 101 is formed in a T-shape, when viewed in the X direction. The opening 101 is formed in a shape obtained by combining a longitudinal hole 102 elongated in the Z direction (an elongated hole) that corresponds to the shape of the folded portion 30 and a lateral hole 103 that extends in the Y direction and corresponds to the shorter peripheral edge portion 52b, when viewed in the X direction.

The protrusion 131 is formed on an outer side in the Y direction in the first holding member 110 (in a portion that does not overlap the lead tab 4 or 5 in a plan view). The protrusion 131 protrudes downward from the lower surface 112 on an outer side in the Y direction of the step 111 in the first holding member 110. The protrusion 131 is formed in a portion that overlaps the through-hole 31 in the first holding member 110 in the plan view. The protrusion 131 is formed in a circular shape in the plan view. One protrusion 131 is formed on each of both outer sides in the Y direction in the first holding member 110. Note that a formation aspect (disposition, shape, the number of pieces, or the like) of the protrusion 131 is not limited to the above, and can be changed according to design specifications.

The recess 132 is formed on an outer side in the Y direction in the second holding member 120 (in a portion that does not overlap the lead tab 4 or 5 in a plan view). The recess 132 is formed by a hole that opens, in the Z direction, a portion located on an outer side in the Y direction of the step 121 in the lateral wall 122 of the second holding member 120. The recess 132 is formed in a portion that overlaps the through-hole 31 in the lateral wall 122 of the second holding member 120 in the plan view. The recess 132 is formed in a circular shape in the plan view. One recess 132 is formed on each of both outer sides in the Y direction in the lateral wall 122 of the second holding member 120. Note that a formation aspect (disposition, shape, the number of pieces, or the like) of the recess 132 is not limited to the above, and can be changed according to design specifications.

The protrusion 131 is formed in a stepped shape in a cross-sectional view. The protrusion 131 includes an enlarged diameter portion 131a, a reduced diameter portion 131b having a diameter smaller than that of the enlarged diameter portion 131a, and a coupling portion 131c that couples the enlarged diameter portion 131ato the reduced diameter portion 131bin a cross-sectional view (the YZ cross-sectional view illustrated in FIG. 7). The enlarged diameter portion 131ais formed in a columnar shape having an outer diameter roughly equal to the inner diameter of the through-hole 31. The reduced diameter portion 131b is formed in a columnar shape having an outer diameter roughly equal to the inner diameter of the recess 132 (a hole 132b). The coupling portion 131c is formed in a truncated cone shape in which the diameter gradually decreases from a lower end of the enlarged diameter portion 131a toward an upper end of the reduced diameter portion 131b. Note that a constitution aspect of the protrusion 131 is not limited to the above, and can be changed according to design specifications.

The recess 132 is formed to include a tapered shape in a cross-sectional view (the YZ cross-sectional view illustrated in FIG. 7). The recess 132 includes a tapered portion 132a, and the hole 132b that is connected to the tapered portion 132a in the cross-sectional view. The tapered portion 132ais formed in a shape in which the diameter gradually decreases from the upper surface 124 located on an outer side in the Y direction of the step 121 in the lateral wall 122 of the second holding member 120 toward the upper end of the hole 132b to correspond to the truncated cone shape of the coupling portion 131c of the protrusion 131 in the cross-sectional view. The hole 132bhas an inner diameter roughly equal to the outer shape of the reduced diameter portion 131b of the protrusion 131. Note that a constitution aspect of the recess 132 is not limited to the above, and can be changed according to design specifications.

In the present embodiment, the outer package 3 and the second holding member 120 can be connected to each other by housing the end of the folded portion 30 of the outer package 3 in the opening 101 of the longitudinal wall 123 of the second holding member 120. Furthermore, in this connection state, the lateral wall 122 of the second holding member 120 is covered with the first holding member 110 from an upper side in the vertical direction through the through-hole 31 of the outer package 3 (the shorter peripheral edge portion 52b). Then, the protrusion 131 of the first holding member 110 can be fitted into the recess 132 of the lateral wall 122 of the second holding member 120. This enables the outer package 3 and the holder 100 to be positioned. For example, positioning can be performed at four corners of the battery body 1A at the time of module assembly (at the time of stacking and pressurization).

For example, when a load has been applied due to buckling, stress is applied to the periphery of the through-hole 31 of the outer package 3 (the shorter peripheral edge portion 52b), deformation occurs, and positioning is not performed in some cases. In contrast, in the present embodiment, the folded portion 30 having particularly high strength in the outer package 3 and the second holding member 120 included in the holder 100 are connected to each other to improve rigidity, and therefore deformation due to an input load (a buckling load) can be reduced. Furthermore, positional accuracy at the time of assembly can be secured, and interference with peripheral components can be prevented.

### Battery Manufacturing Method

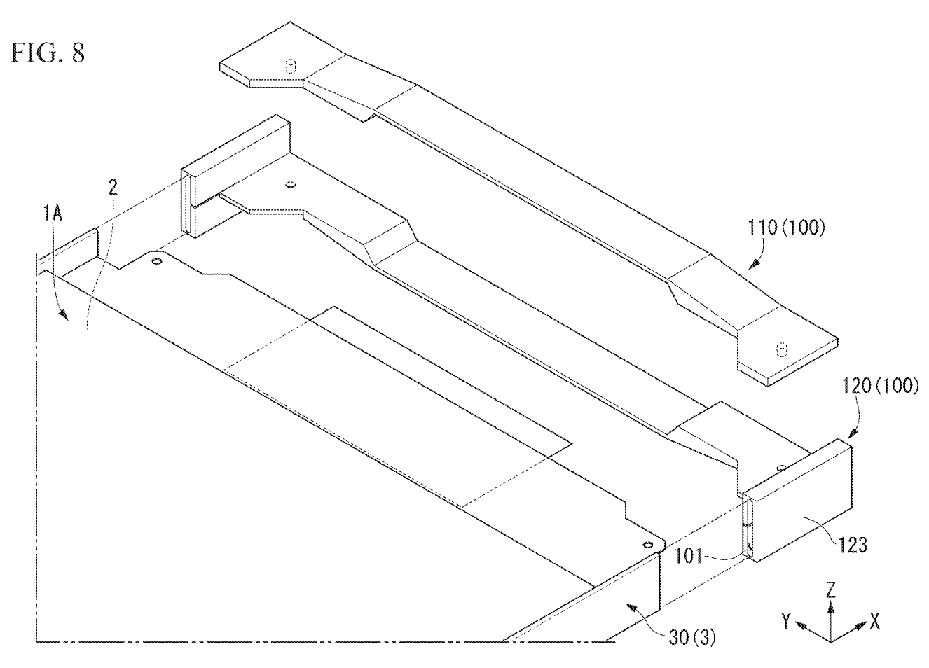

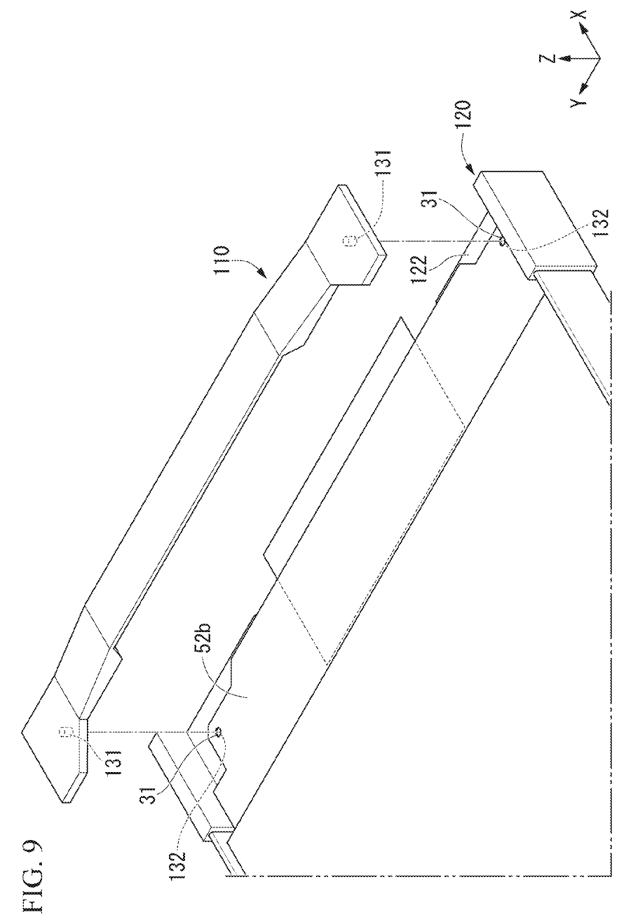

FIG. 8 is a diagram explaining one process of a battery manufacturing method according to the embodiment. FIG. 9 is a diagram that follows FIG. 8 and explains one process of the battery manufacturing method.

With further reference to FIGS. 8 and 9, the battery manufacturing method according to the present embodiment includes: preparing the electrode stack 2 formed in a rectangular parallelepiped shape, the outer package 3 of a laminated film, the outer package 3 including the folded portion 30 on a longer side of the electrode stack 2 and housing the electrode stack 2, the first holding member 110, and the second holding member 120 including the opening 101 capable of housing the end of the folded portion 30, the first holding member 110 and the second holding member 120 serving as the holder 100 that is connected to the folded portion 30; housing the end of the folded portion 30 of the outer package 3 in the opening 101 of the second holding member 120; and attaching the first holding member 110 to the second holding member 120 in a state where the end of the folded portion 30 is housed.

First, the end of the folded portion 30 of the outer package 3 included in the battery body 1A is housed in (inserted into) the opening 101 of the longitudinal wall 123 of the second holding member 120 located on a lower side in a vertical direction. For example, the ends of the respective folded portions 30 located on both sides in the Y direction in the outer package 3 are housed in the respective openings 101 of the longitudinal walls 123 located on both sides in the Y direction in the second holding member 120, and are moved to a predetermined position in the X direction. This causes a state where the respective folded portions 30 of the outer package 3 are housed in (have been inserted into) the respective openings 101 of the longitudinal walls 123.

Next, the first holding member 110 is disposed to cover the lateral wall 122 of the second holding member 120 from an upper side in the vertical direction with the outer package 3 (the shorter peripheral edge portions 52b) interposed therebetween. At this time, the protrusions 131 of the first holding member 110 are fitted into the recesses 132 of the lateral wall 122 of the second holding member 120 through the through-holes 31 of the outer package 3 (the shorter peripheral edge portions 52b). This enables the outer package 3 and the holder 100 to be positioned.

By performing the processes described above, the manufacture of the all-solid-state battery 1 including the battery body and the holder 100 is completed.

In the present embodiment, the ends of the folded portions 30 of the outer package 3 are housed in the openings 101 of the second holding member 120 at a lower stage prior to the attachment of the first holding member 110, and this can prevent a load from being applied to the peripheries of the through-holes 31 of the outer package 3 (the shorter peripheral edge portions 52b). This makes it possible to reduce deformation due to an input load (a buckling load), secure positional accuracy at the time of assembly, and prevent interference with peripheral components.

### Battery Module

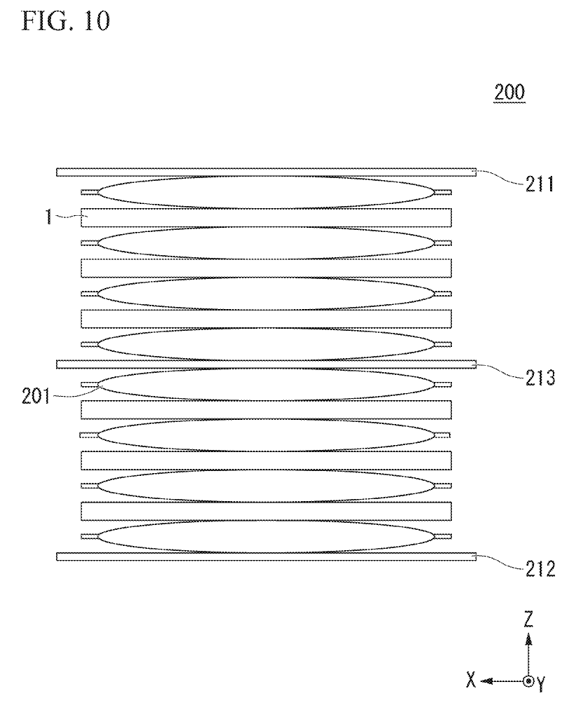

FIG. 10 is a perspective view of a battery module 200 according to the embodiment.

As illustrated in FIG. 10, the battery module 200 includes the all-solid-state battery 1 described above, and an elastic member 201 that is adjacent to the all-solid-state battery 1 in the thickness direction. The battery module 200 is formed by alternately disposing (stacking) a plurality of all-solid-state batteries 1 and a plurality of elastic members 201.

In the example of FIG. 10, the battery module 200 includes a first plate-shaped member 211, a second plate-shaped member 212 that faces the first plate-shaped member 211 in the thickness direction, and a third plate-shaped member 213 that is disposed between the first plate-shaped member 211 and the second plate-shaped member 212. The plurality of elastic members 201 is disposed between the first plate-shaped member 211 and the third plate-shaped member 213 and between the second plate-shaped member 212 and the third plate-shaped member 213, and the all-solid-state battery 1 is disposed between adjacent elastic members 201. Note that an installation aspect of each of the plate-shaped members is not limited to the above, and can be changed according to design specifications.

### Operation and Effects

As described above, the all-solid-state battery 1 according to the embodiment described above includes the electrode stack 2 formed in a rectangular parallelepiped shape, the outer package 3 of a laminated film, the outer package 3 including the folded portion 30 on a longer side of the electrode stack 2 and housing the electrode stack 2, and the holder 100 that is disposed on a shorter side of the electrode stack 2 and is connected to the folded portion 30.

By employing this constitution, the holder 100 is connected to the folded portion 30 of the outer package 3, and therefore a separate member configured to connect the outer package 3 to the holder 100 (for example, the side holder disclosed in Japanese Unexamined Patent Application, First Publication No. 2022-14715, or the like) is not required. Accordingly, the number of parts can be reduced. This results in contribution to improvements in energy efficiency.

In the embodiment described above, the holder 100 includes the opening 101 that houses the end of the folded portion 30.

By employing this constitution, the outer package 3 and the holder 100 can be connected to each other by housing the end of the folded portion 30 of the outer package 3 in the opening 101 of the holder 100. This contributes to space saving in comparison with the case of connection using a holding mechanism such as a chucking mechanism. As a result, the battery can be reduced in size, and the volumetric energy density can be made efficient.

In the embodiment described above, the holder 100 includes the first holding member 110 and the second holding member 120 that are disposed to be superimposed onto each other in the thickness direction of the electrode stack 2. The opening 101 is formed in the second holding member 120.

By employing this constitution, the first holding member 110 and the second holding member 120 are disposed to be superimposed onto each other in the thickness direction of the electrode stack 2, and therefore the outer package 3 can be more suitably protected from external factors. Furthermore, the outer package 3 and the holder 100 can be connected to each other by housing the end of the folded portion 30 of the outer package 3 in the opening 101 of the second holding member 120. Therefore, connection becomes easy in comparison with a case where the end of the folded portion 30 of the outer package 3 is housed in the opening of each of the first holding member 110 and the second holding member 120.

In the embodiment described above, the outer package 3 includes the through-hole 31 that is open in the thickness direction. The holder 100 includes the uneven structure 130 that is fitted through the through-hole 31, in a portion that corresponds to the through-hole 31.

By employing this constitution, the uneven structure 130 enables the outer package 3 and the holder 100 to be positioned. As a result, the outer package 3 and the holder 100 can be prevented from being relatively displaced (relative displacement can be restricted).

In the embodiment described above, the uneven structure 130 includes the protrusion 131 that is formed in the first holding member 110 and protrudes in the thickness direction, and the recess 132 that is formed in the second holding member 120, the protrusion 131 being capable of being fitted into the recess 132.

By employing this constitution, the outer package 3 and the holder 100 can be positioned by fitting the protrusion 131 of the first holding member 110 into the recess 132 of the second holding member 120. Therefore, positioning is easily performed in comparison with a case where the uneven structure 130 includes a hole formed in each of the first holding member 110 and the second holding member 120, and a shaft that is inserted into each of the holes.

In the embodiment described above, the first holding member 110 is disposed vertically above the second holding member 120.

By employing this constitution, the outer package 3 and the holder 100 can be connected to each other by housing the end of the folded portion 30 of the outer package 3 in the opening 101 of the second holding member 120. Furthermore, in this connection state, the second holding member 120 is covered with the first holding member 110 from an upper side in the vertical direction, and the protrusion 131 of the first holding member 110 is fitted into the recess 132 of the second holding member 120, and therefore the outer package 3 and the holder 100 can be positioned. This facilitates assembly work in comparison with a case where the first holding member 110 is disposed on a lower side in the vertical direction of the second holding member 120.

The all-solid-state battery 1 according to the embodiment described above includes: the electrode stack 2 that is formed in a rectangular parallelepiped shape, and includes the positive electrode layers 6 and 7 formed in a plate shape, the negative electrode layers 8 and 9 facing the positive electrode layers 6 and 7 in the thickness direction, and the solid electrolyte layers 11 and 12 disposed between the positive electrode layers 6 and 7 and the negative electrode layers 8 and 9; the outer package 3 of a laminated film, the outer package 3 including the folded portion 30 on a longer side of the electrode stack 2 and housing the electrode stack 2; and the holder 100 that is disposed on a shorter side of the electrode stack 2 and is connected to the folded portion 30.

By employing this constitution, in the all-solid-state battery 1, the holder 100 is connected to the folded portion 30 of the outer package 3, and therefore a separate member configured to connect the outer package 3 to the holder 100 (for example, the side holder disclosed in Japanese Unexamined Patent Application, First Publication No. 2022-14715, or the like) is not required. Accordingly, the number of parts can be reduced. This results in contribution to improvements in energy efficiency.

In the embodiment described above, the negative electrode layers 8 and 9 include the negative electrode active material layer 15 made of an active material of a lithium-based material or a silicon-based material.

By employing this constitution, in the all-solid-state battery 1 including a Li negative electrode or a Si negative electrode, displacement can be prevented at the time of stacking.

The battery module 200 according to the embodiment described above includes the all-solid-state battery 1 described above, and the elastic member 201 that is adjacent to the all-solid-state battery 1 in the thickness direction.

By employing this constitution, in the battery module 200, the holder 100 is connected to the folded portion 30 of the outer package 3, and therefore a separate member configured to connect the outer package 3 to the holder 100 (for example, the side holder disclosed in Japanese Unexamined Patent Application, First Publication No. 2022-14715, or the like) is not required. Accordingly, the number of parts can be reduced. This results in contribution to improvements in energy efficiency. Furthermore, in applying pressure after the all-solid-state battery 1 and the elastic member 201 have been stacked, the all-solid-state battery 1 or the elastic member 201 can be prevented from being damaged due to a load at the time of applying pressure.

The battery manufacturing method according to the embodiment described above includes: preparing the electrode stack 2 formed in a rectangular parallelepiped shape, the outer package 3 of a laminated film, the outer package 3 including the folded portion 30 on a longer side of the electrode stack 2 and housing the electrode stack 2, the first holding member 110, and the second holding member 120 including the opening 101 capable of housing the end of the folded portion 30, the first holding member 110 and the second holding member 120 serving as the holder 100 that is connected to the folded portion 30; housing the end of the folded portion 30 of the outer package 3 in the opening 101 of the second holding member 120; and attaching the first holding member 110 to the second holding member 120 in a state where the end of the folded portion 30 is housed.

By employing this method, the first holding member 110 can be attached to the second holding member 120 in a state where the end of the folded portion 30 of the outer package 3 is housed in the opening 101 of the second holding member 120. As a result, a separate member configured to connect the outer package 3 to the holder 100 (for example, the side holder disclosed in Japanese Unexamined Patent Application, First Publication No. 2022-14715, or the like) is not required. Accordingly, the number of parts can be reduced. This results in contribution to improvements in energy efficiency. This also results in contribution to space saving in comparison with the case of connection using a holding mechanism such as a chucking mechanism. As a result, the battery can be reduced in size, and the volumetric energy density can be made efficient.

### Modifications

In the embodiment described above, description has been provided by using an example where the holder includes the opening that houses the end of the folded portion, but this is not restrictive. For example, the holder may include a portion into which the folded portion can be inserted. An aspect in which the holder is connected to the folded portion of the outer package can be changed according to design specifications.

In the embodiment described above, description has been provided, by using an example where the holder includes the first holding member and the second holding member that are disposed to be superimposed onto each other in the thickness direction of the electrode stack, and the opening is formed in the second holding member, but this is not restrictive. For example, the opening may be formed in the first holding member. For example, the opening may be formed in each of the first holding member and the second holding member. A formation aspect of the opening can be changed according to design specifications.

In the embodiment described above, description has been provided, by using an example where the through-hole that is open in the thickness direction is formed in the outer package, and the holder includes the uneven structure that is fitted through the through-hole, in a portion that corresponds to the through-hole, but this is not restrictive. For example, the through-hole that is open in the thickness direction does not necessarily need to be formed in the outer package. For example, the holder does not necessarily need to include the uneven structure in the portion that corresponds to the through-hole. A formation aspect of the through-hole and an installation aspect of the uneven structure can be changed according to design specifications.

In the embodiment described above, description has been provided, by using an example where the uneven structure includes the protrusion that is formed in the first holding member and protrudes in the thickness direction, and the recess that is formed in the second holding member, the protrusion being capable of being fitted into the recess, but this is not restrictive. For example, the uneven structure may include a protrusion that is formed in the second holding member and protrudes in the thickness direction, and a recess that is formed in the first holding member, the protrusion being capable of being fitted into the recess. For example, the uneven structure may include a hole that is formed in each of the first holding member and the second holding member, and a shaft that is inserted into each of the holes. A constitution aspect of the uneven structure can be changed according to design specifications.

In the embodiment described above, description has been provided by using an example where the first holding member is disposed vertically above the second holding member, but this is not restrictive. For example, the first holding member may be disposed vertically below the second holding member. A disposition aspect of the first holding member relative to the second holding member can be changed according to design specifications.

In the embodiment described above, description has been provided by using an all-solid-state battery as an example of a battery, but this is not restrictive. For example, the battery may be a secondary battery such as a lithium-ion secondary battery or a nickel-hydrogen battery. The battery may be a battery other than the all-solid-state battery and the secondary battery. For example, a battery to which the present invention is applied can be changed according to design specifications.

Heretofore, the mode for carrying out the present invention has been described by using the embodiment, but the present invention is not limited to such an embodiment, and various modifications and substitutions can be made without departing from the gist of the present invention.

What is claimed is:

1. A battery comprising:
an electrode stack that is formed in a rectangular parallelepiped shape;
an outer package of a laminated film, the outer package including a folded portion on a longer side of the electrode stack and housing the electrode stack; and
a holder that is disposed on a shorter side of the electrode stack and is connected to the folded portion.

2. The battery according to claim 1, wherein
an opening that houses an end of the folded portion is formed in the holder.

3. The battery according to claim 2, wherein
the holder includes a first holding member and a second holding member that are disposed to be superimposed onto each other in a thickness direction of the electrode stack, and
the opening is formed in any one of the first holding member and the second holding member.

4. The battery according to claim 3, wherein
a through-hole that is open in the thickness direction is formed in the outer package, and
the holder includes an uneven structure that is fitted through the through-hole, in a portion that corresponds to the through-hole.

5. The battery according to claim 4, wherein
the uneven structure includes:
a protrusion that is formed in any one of the first holding member and the second holding member and protrudes in the thickness direction; and
a recess that is formed in another of the first holding member and the second holding member, the protrusion being capable of being fitted into the recess.

6. The battery according to claim 5, wherein
the opening is formed in the second holding member, and
the first holding member is disposed vertically above the second holding member.

7. An all-solid-state battery comprising:
an electrode stack that is formed in a rectangular parallelepiped shape, and includes a positive electrode layer formed in a plate shape, a negative electrode layer facing the positive electrode layer in a thickness direction, and a solid electrolyte layer disposed between the positive electrode layer and the negative electrode layer;
an outer package of a laminated film, the outer package including a folded portion on a longer side of the electrode stack and housing the electrode stack; and
a holder that is disposed on a shorter side of the electrode stack and is connected to the folded portion.

8. The all-solid-state battery according to claim 7, wherein
the negative electrode layer includes a negative electrode active material layer made of an active material of a lithium-based material or a silicon-based material.

9. A battery module comprising:
the all-solid-state battery according to claim 7; and
an elastic member that is adjacent to the all-solid-state battery in the thickness direction.

10. A battery manufacturing method comprising:
preparing an electrode stack formed in a rectangular parallelepiped shape, an outer package of a laminated film, the outer package including a folded portion on a longer side of the electrode stack and housing the electrode stack, a first holding member, and a second holding member including an opening capable of housing an end of the folded portion, the first holding member and the second holding member serving as a holder that is connected to the folded portion;
housing the end of the folded portion of the outer package in the opening of the second holding member; and
attaching the first holding member to the second holding member in a state where the end of the folded portion is housed.
